(19) United States
(12) Patent Application Publication
(10) Pub. No.: US 2014/0044300 A1
(43) Pub. Date: Feb. 13, 2014

(54) ELECTRONIC APPARATUS, SOUND QUALITY IMPROVEMENT METHOD, AND SOUND QUALITY IMPROVEMENT MEMBER

(71) Applicant: Kabushiki Kaisha Toshiba, Tokyo (JP)

(72) Inventors: Masataka Osada, Kawasaki-shi (JP); Makoto Isahaya, Tokyo (JP)

(73) Assignee: Kabushiki Kaisha Toshiba, Tokyo (JP)

(21) Appl. No.: 14/030,816

(22) Filed: Sep. 18, 2013

Related U.S. Application Data
(63) Continuation of application No. PCT/JP2013/058450, filed on Mar. 15, 2013.

(30) Foreign Application Priority Data
Aug. 8, 2012 (JP) 2012-176341

(51) Int. Cl. H04R 1/02

(52) U.S. Cl. CPC H04R 1/02
USPC 381/387; 181/199

(57) ABSTRACT

According to one embodiment, an electronic apparatus includes a speaker and a matching section. The speaker includes an output section configured to output sound and an opening which exposes the output section. The matching section closes the opening and includes a slit which partially exposes the output section.

### CROSS REFERENCE TO RELATED APPLICATIONS

This application is a Continuation Application of PCT Application No. PCT/JP2013/058450, filed Mar. 15, 2013 and based upon and claiming the benefit of priority from Japanese Patent Application No. 2012-176341, filed Aug. 8, 2012, the entire contents of all of which are incorporated herein by reference.

### FIELD

Embodiments described herein relate generally to an electronic apparatus, sound quality improvement method, and sound quality improvement member.

### BACKGROUND

Electronic apparatuses, for example, notebook computers, tablet computers, smartphones, portable music players, etc., are increasingly required to be smaller and achieve higher component densities. Small-diameter speakers are used in these electronic apparatuses.

In these electronic apparatuses, impedance matching is performed by various methods to improve the sound quality of the speakers. For example, the front surfaces of the speakers are covered by a plate, which is formed with a plurality of holes for audio output. However, this arrangement still requires improvement, in order to achieve good reproduction of low-frequency sound output from the speakers.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing a notebook computer according to a first embodiment;

FIG. 2 is an exemplary perspective view showing a matching section of the first embodiment;

FIG. 3 is an exemplary sectional view showing the matching section of the first embodiment;

FIG. 4 is an exemplary perspective view showing a matching section according to a second embodiment;

FIG. 5 is an exemplary perspective view showing a matching section according to a third embodiment;

FIG. 6 is an exemplary perspective view showing a speaker unit according to a fourth embodiment;

FIG. 7 is an exemplary perspective view showing a matching section and speaker of the fourth embodiment;

FIG. 8 is an exemplary diagram comparatively showing audio output characteristics of the fourth embodiment and the prior art;

FIG. 9 is an exemplary perspective view showing a tablet computer according to a fifth embodiment;

FIG. 10 is an exemplary sectional view showing a part of the tablet computer of the fifth embodiment;

FIG. 11 is an exemplary sectional view of a part of the tablet computer of the fifth embodiment taken along line F11-F11 of FIG. 10; and

FIG. 12 is an exemplary exploded perspective view showing a matching section and speaker according to a sixth embodiment.

### DETAILED DESCRIPTION

Various embodiments will be described hereinafter with reference to the accompanying drawings.

In general, according to one embodiment, an electronic apparatus includes a speaker and a matching section. The speaker includes an output section configured to output sound and an opening which exposes the output section. The matching section closes the opening and includes a slit which partially exposes the output section.

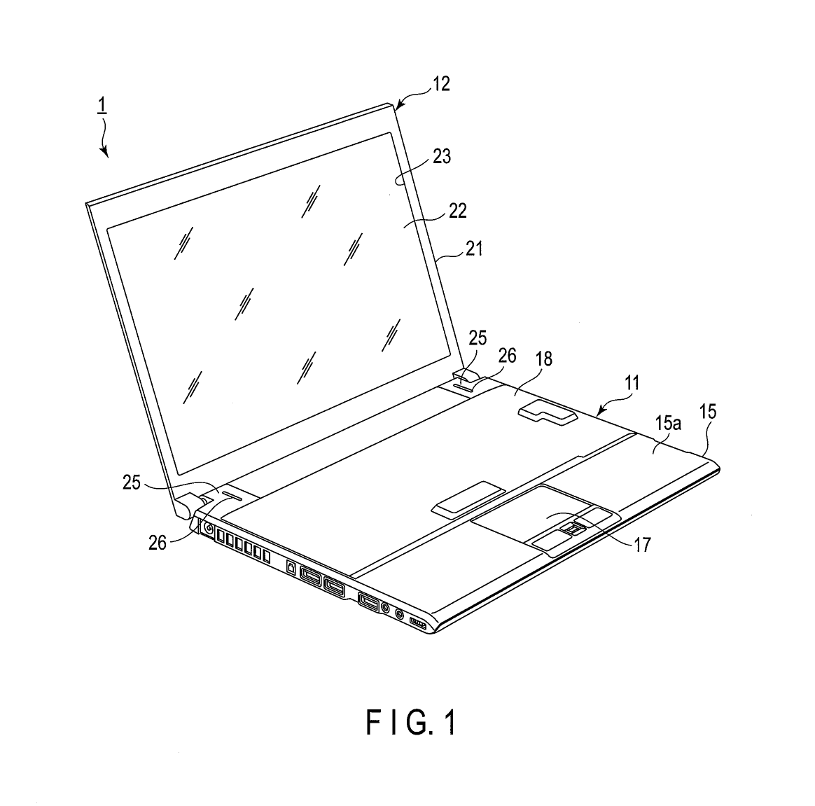

A first embodiment will now be described with reference to FIGS. 1 to 3. In this specification, the near or user side is defined as forward; the far side from the user as rearward, the user's left-hand side as leftward, the user's right-hand side as rightward, and the upper and lower sides with respect to the user as upward and downward, respectively. Further, each element that can be expressed in different ways may sometimes be represented by one or more alternative examples of expressions. However, this neither denies that an element that is not given any alternative expression can be differently expressed, nor restricts other expressions that are not exemplified.

FIG. 1 is an exemplary perspective view showing a notebook computer 1 according to a first embodiment. The notebook computer 1 is an example of an electronic apparatus. As shown in FIG. 1, the computer 1 comprises a main unit 11 and display unit 12.

The main unit 11 comprises a main housing 15. The main housing 15 is an example of a sound quality improvement member as well as an example of a housing. The main housing 15 is made of, for example, a resin. The main housing 15 is not limited to this and may be made of another rigid material that does not absorb sound.

A touchpad 17 and keyboard 18 are disposed on a top surface 15a of the main housing 15. Keys of the keyboard 18 are not shown in FIG. 1. The main unit 11 comprises various components, such as a motherboard, hard disk drive (HDD), optical disc drive (ODD), and battery.

The display unit 12 comprises a display housing 21 and display module 22. The display module 22 is, for example, a liquid-crystal display. The display module 22 is not limited to this and may be another display, such as an organic electroluminescent display. The display housing 21 accommodates the display module 22.

The display housing 21 comprises a rectangular display opening 23. The display opening 23 is provided in the front surface of the display housing 21. A surface of the display module 22 on which an image is displayed is exposed through the display opening 23.

An end portion of the display unit 12 is pivotably connected to the rear end portion of the main unit 11 by a hinge. The display unit 12 is pivotable between a closed position where it lies on the main unit 11 and an open position where it rises from the rear end portion of the main unit 11, as shown in FIG. 1.

A pair of matching sections 25 are disposed on the main housing 15. The matching sections 25 may be variously represented as, for example, wall portions, plate portions, or baffles. The matching sections 25 are a part of the main housing 15 and form a part of its top surface 15a.

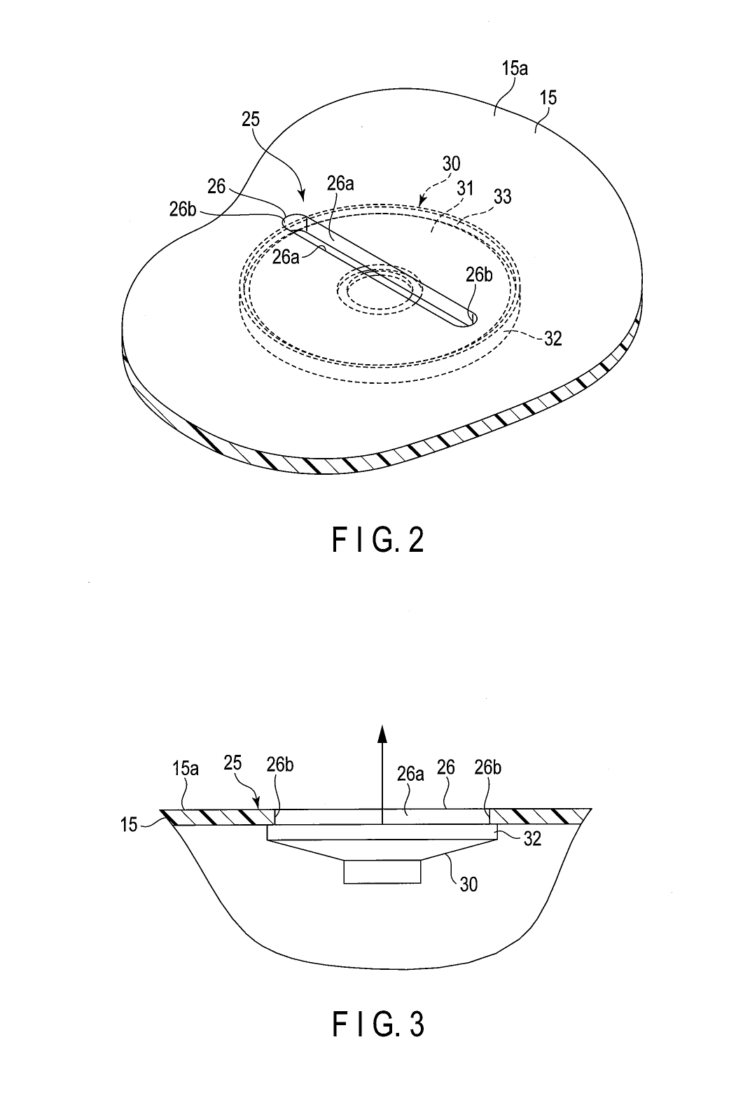

FIG. 2 is an exemplary perspective view showing one of the matching sections 25. FIG. 3 is an exemplary sectional view showing the matching section 25. As shown in FIG. 2, each matching section 25 comprises a single slit 26. In this specification, the slit is a hole having longitudinal and transverse dimensions or a combination of a plurality of such holes. The slit 26 may be alternatively expressed as, for example, an opening, slot, gap, narrow gap, groove, recess, or notch.

The slit 26 comprises a pair of parallel side edges 26a and a pair of end edges 26b. Each end edge 26b spans between its corresponding end portions of the two side edges 26a. Although each end edge 26b is formed in a circular arc, it may alternatively be formed of, for example, one or more straight portions. The side edges 26a of the slit 26 extend longitudinally relative to the main unit 11.

The distance between the pair of side edges 26a ranges, for example, from 0.5 to 3 mm. The distance between the pair of end edges 26b ranges, for example, from 10 to 30 mm. In other words, the longitudinal and transverse dimensions of the slit 26 range from 10 to 30 mm and from 0.5 to 3 mm, respectively. However, the longitudinal and transverse dimensions of the slit 26 are not limited to these ranges.

As shown in FIG. 2, a pair of speakers 30 are accommodated in the main housing 15. The speakers 30 may be alternatively expressed as components, audio output sections, or sound output devices. The pair of speakers 30 are located corresponding to the pair of matching sections 25.

Each speaker 30 comprises a diaphragm 31 and peripheral edge portion 32. The diaphragm 31 is an example of an output section. The diaphragm 31 may be alternatively expressed as, for example, a vibration unit, audio output section, or audio generation unit.

The diaphragm 31 is substantially circular. The diaphragm 31 is caused to vibrate by various components, such as a voice coil, attached to the speaker 30. The diaphragm 31 vibrates air to output a sound.

The diameter of the diaphragm 31 ranges, for example, from 10 to 30 mm. The diameter of the diaphragm 31 is not limited to this range and may be larger or smaller than this range. The longitudinal dimension and area of the slit 26 are determined according to the diameter and area of the diaphragm 31.

The peripheral edge portion 32 is in the form of a substantially circular frame surrounding the diaphragm 31. The peripheral edge portion 32 comprises an opening 33. Inside the opening 33, the diaphragm 31 is supported for vibration by the peripheral edge portion 32. The diaphragm 31 is exposed through the opening 33.

As shown in FIG. 3, the front end portion of the peripheral edge portion 32 in which the opening 33 opens is in contact with an inner surface 25b of the matching section 25. The inner surface 25b of the matching section 25 forms a part of the inner surface of the main housing 15.

The peripheral edge portion 32 is secured to the inner surface 25b by means of, for example, a component in the main housing 15 or adhesive. Since the peripheral edge portion 32 is in contact with the inner surface 25b, the matching section 25 closes the opening 33 of the speaker 30. The diaphragm 31 is separated from the inner surface 25b so that it can vibrate.

As shown in FIG. 2, the slit 26 allows the diaphragm 31 to be partially exposed. More specifically, the slit 26 extends above the central portion of the diaphragm 31. The longitudinal dimension of the slit 26 is no greater than the diameter of the diaphragm 31. Therefore, the area of the slit 26 is smaller than that of the diaphragm 31. Since the slit 26 is located and designed in this manner, a part of the diaphragm 31 is exposed through the slit 26. The diaphragm 31 is exposed through the single slit 26 only and not through any other holes or the like. The longitudinal dimension of the slit 26 may be greater than the diameter of the diaphragm 31.

If the speaker 30 outputs sound, as indicated by an arrow in FIG. 3, this sound is output from the notebook computer 1 through the slit 26. The sound is subjected to impedance matching in the slit 26. In other words, the slit 26 performs impedance matching between the air and the speaker 30. Thus, attenuation at low frequencies can be suppressed, and the sound output from the speaker 30 can be reproduced to the lower limit of the frequency range.

According to the notebook computer 1 of the first embodiment, the slit 26 is disposed in each matching section 25 that closes the opening 33 of each speaker 30. Thus, the slit 26 serves for impedance matching between the air and the speaker 30. Accordingly, low-frequency sound output from the speaker 30 can be satisfactorily reproduced. Specifically, a satisfactory frequency response and dynamic range of the speaker 30 can be achieved, so that good sound quality can be obtained. This impedance matching requires neither a perforated plate spaced apart from the speaker 30 provided with holes nor an enclosure that covers the rear portion of the speaker 30. Thus, it is possible to suppress restrictions on the design of the notebook computer 1 or increase in the cost of the computer 1.

The impedance matching between the air and the speaker 30 is performed by the slit 26. Therefore, when compared with the case where a perforated plate provided with the holes is used, for example, that part of the speaker 30 from which sound is output is so inconspicuous that the appearance of the notebook computer 1 can be improved.

The matching sections 25 are disposed on the main housing 15. Thus, it is unnecessary to provide matching sections independent of the main housing 15. Despite the use of the matching sections 25 for improving the low-frequency sound quality, therefore, an increase in the component density in the notebook computer 1 and cost of the notebook computer 1 can be suppressed, so that the computer 1 can be miniaturized and made thinner.

The diaphragm 31 of each speaker 30 is exposed through the single slit 26 only. Accordingly, impedance matching can be efficiently performed, and the low-frequency sound quality can be further improved.

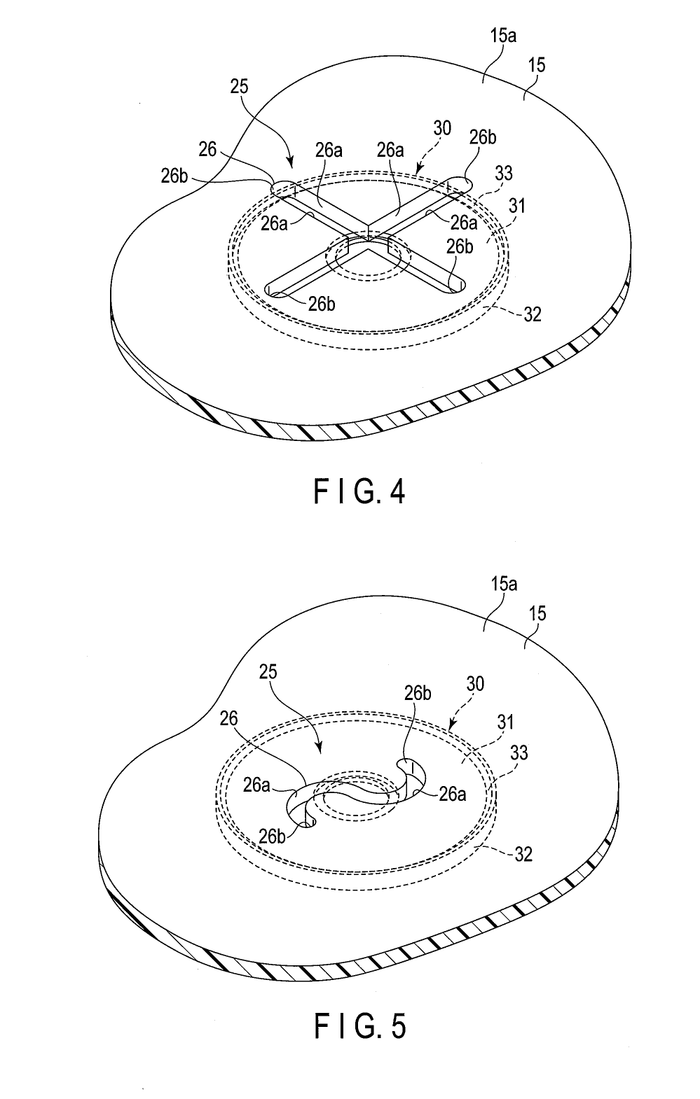

A second embodiment will now be described with reference to FIG. 4. In the description of at least one of the following embodiments, like reference numbers are used to designate constituent elements having the same functions as those in the first embodiment, and a detailed description thereof may be partially or entirely omitted.

FIG. 4 is an exemplary perspective view showing a matching section 25 according to the second embodiment. As shown in FIG. 4, a slit 26 of the second embodiment is cruciform. Specifically, the slit 26 is a hole that combines a plurality of holes having longitudinal and transverse dimensions.

In the second embodiment arranged in this manner, as in the first embodiment, impedance matching between the air and a speaker 30 can be performed by the slit 26. Thus, low-frequency sound output from the speaker 30 can be satisfactorily reproduced.

A third embodiment will now be described with reference to FIG. 5. FIG. 5 is an exemplary perspective view showing a matching section 25 according to the third embodiment. As shown in FIG. 5, a slit 26 of the third embodiment is curved.

In the third embodiment arranged in this manner, as in the first embodiment, impedance matching between the air and a speaker 30 can be performed by the slit 26. Thus, low-frequency sound output from the speaker 30 can be satisfactorily reproduced.

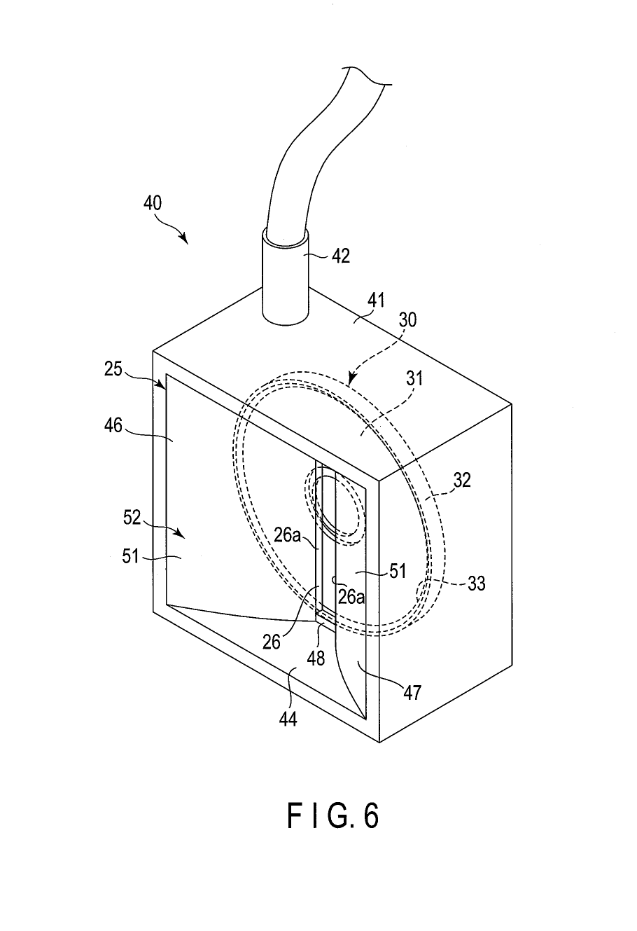

A fourth embodiment will now be described with reference to FIGS. 6 to 8. FIG. 6 is an exemplary perspective view showing a speaker unit 40 according to the fourth embodiment. As shown in FIG. 6, the speaker unit 40 is an example of an electronic apparatus, which is a so-called external speaker connected to, for example, a notebook computer, tablet computer, smartphone, or portable music player.

The speaker unit 40 comprises a matching section 25, speaker 30, speaker housing 41, and joint 42. The speaker housing 41 is in the form of a box, which accommodates the matching section 25 and speaker 30. The speaker housing 41 comprises a rectangular front opening 44.

The joint 42 is a combination of a cable and plug to be connected to, for example, an earphone jack. The cable of the joint 42 extends from the top surface of the speaker housing 41. The plug to be inserted into the earphone jack is disposed on an end portion of the cable of the joint 42. The joint 42 is not limited to this and may be another connecting part, such as a USB connector.

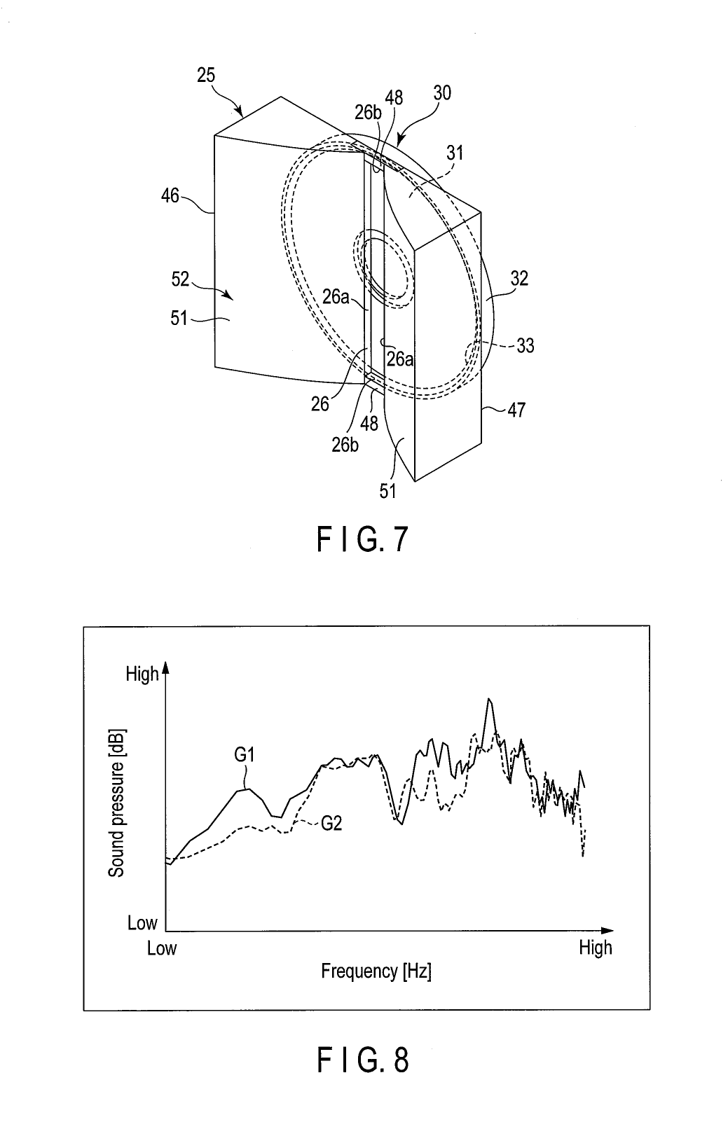

FIG. 7 is an exemplary perspective view showing the matching section 25 and speaker 30 according to the fourth embodiment. As shown in FIG. 7, the matching section 25 of the fourth embodiment is a component independent of the speaker housing 41. In the fourth embodiment, the matching section 25 is an example of a sound quality improvement member.

The matching section 25 is made of, for example, a resin. The matching section 25 is not limited to this and may be made of another rigid material that does not absorb sound. The matching section 25 comprises a first member 46, second member 47, and a pair of slit stops 48. Each slit stop 48 is an example of a junction.

The first and second members 46 and 47 are each substantially in the form of a triangular prism. The members 46 and 47 are arranged side by side with a slit 26 between them. In other words, the slit 26 is defined between the members 46 and 47.

The first and second members 46 and 47 form an inner surface 25b of the matching section 25. The members 46 and 47 each have a horn surface 51. The horn surface 51 is located opposite the inner surface 25b.

The horn surfaces 51 are connected individually to the side edges 26a of the slit 26. The horn surface 51 of the first member 46 is inclined relative to the inner surface 25b of the matching section 25. The horn surface 51 of the first member 46 is a curved surface that recedes from the inner surface 25b with distance from the second member 47.

The horn surface 51 of the second member 47 is inclined relative to the inner surface 25b of the matching section 25. The horn surface 51 of the second member 47 is a curved surface that recedes from the inner surface 25b with distance from the first member 46. The horn surface 51 may alternatively be a flat surface.

A horn portion 52 is defined by the respective horn surfaces 51 of the first and second members 46 and 47. The horn portion 52 is a so-called short horn, which is connected to the slit 26. In other words, a passage of sound that is continuous with the slit 26 is in the shape of a horn.

One of the slit stops 48 connects the respective upper ends of the first and second members 46 and 47. The other slit stop 48 connects the respective lower ends of the members 46 and 47. Thus, the slit stops 48 connect the first and second members 46 and 47. The slit stops 48 form end edges 46b of the slit 26.

The slit stops 48 are secured to the first and second members 46 and 47 by, for example, being fitted individually into grooves in the members 46 and 47. Alternatively, the slit stops 48 may be secured to the first and second members 46 and 47 with, for example, an adhesive.

FIG. 8 is an exemplary diagram comparatively showing audio output characteristics of the fourth embodiment and the prior art. In the diagram of FIG. 8, the ordinate and abscissa represent the sound pressure and frequency, respectively. In this diagram, full-line and broken-line graphs G1 and G2 represent audio outputs according to the fourth embodiment and the prior art, respectively. The prior art audio output is determined for sound output through a plurality of circular holes of a plate located at a distant from the speaker diaphragm.

As shown in FIG. 8, audio output G1 of the fourth embodiment has a sound pressure higher than that of audio output G2 of the prior art in a low-frequency range. Thus, the speaker unit 40 of the fourth embodiment can satisfactorily reproduce low-frequency sound output from the speaker 30.

As shown in FIG. 8, the range where the sound pressure of audio output G1 of the fourth embodiment is higher than that of audio output G2 of the prior art is not limited to a low-frequency range. The sound pressure of audio output G1 of the fourth embodiment is higher than that of audio output G2 of the prior art in an area ranging from the center of the abscissa to a region slightly on the right-hand side.

According to the speaker unit 40 of the fourth embodiment, the matching section 25 comprises the horn portion 52 connected to the slit 26. The horn portion 52 serves to amplify sound that is output through the slit 26. In this way, a high sound volume can be obtained even with a small-diameter speaker.

The first and second members 46 and 47 are connected to each other by the slit stops 48. Thus, the width of the slit 26 can be changed by replacing, for example, the slit stops 48 with new ones.

Therefore, an increase in material cost can be suppressed even in a case where a plurality of types of matching sections 25 that are different in the width of the slit 26 are provided.

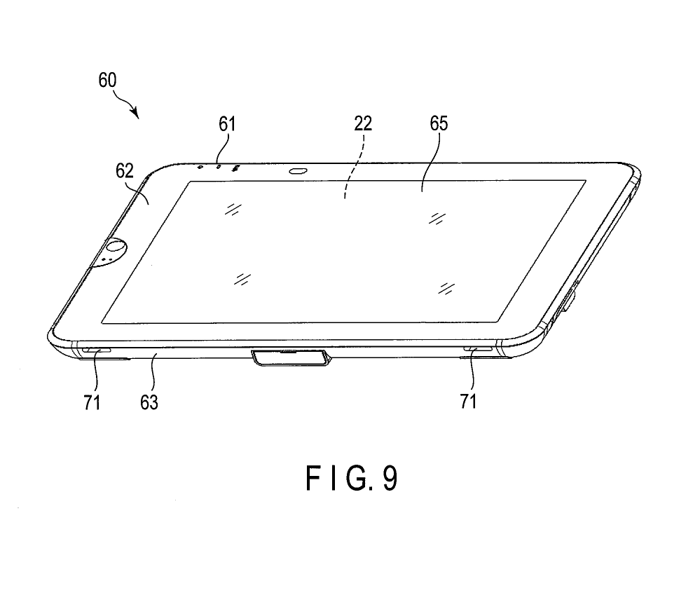

A fifth embodiment will now be described with reference to FIGS. 9 to 11. FIG. 9 is an exemplary perspective view showing a tablet computer 60 according to the fifth embodiment. The tablet computer 60 is an example of an electronic apparatus.

As shown in FIG. 9, the tablet computer 60 comprises a display module 22 and tablet housing 61. The tablet housing 61 is an example of a housing. The tablet housing 61 comprises a front cover 62 and rear cover 63.

The front cover 62 is secured to the rear cover 63. The front cover 62 comprises a rectangular light-transmitting portion 65. The light-transmitting portion 65 is, for example, a transparent area, through which the image display surface of the display module 22 is exposed.

The tablet housing 61 comprises a pair of output ports 71. The output ports 71 are outwardly opening holes arranged in a side surface of the tablet housing 61. The output ports 71 are not limited to this arrangement and may alternatively be located in another portion of the tablet housing 61.

Each output port 71 is formed of an edge portion of the front cover 62 and a recess in an edge portion of the rear cover 63. The output ports 71 may alternatively be holes in, for example, the rear cover 63.

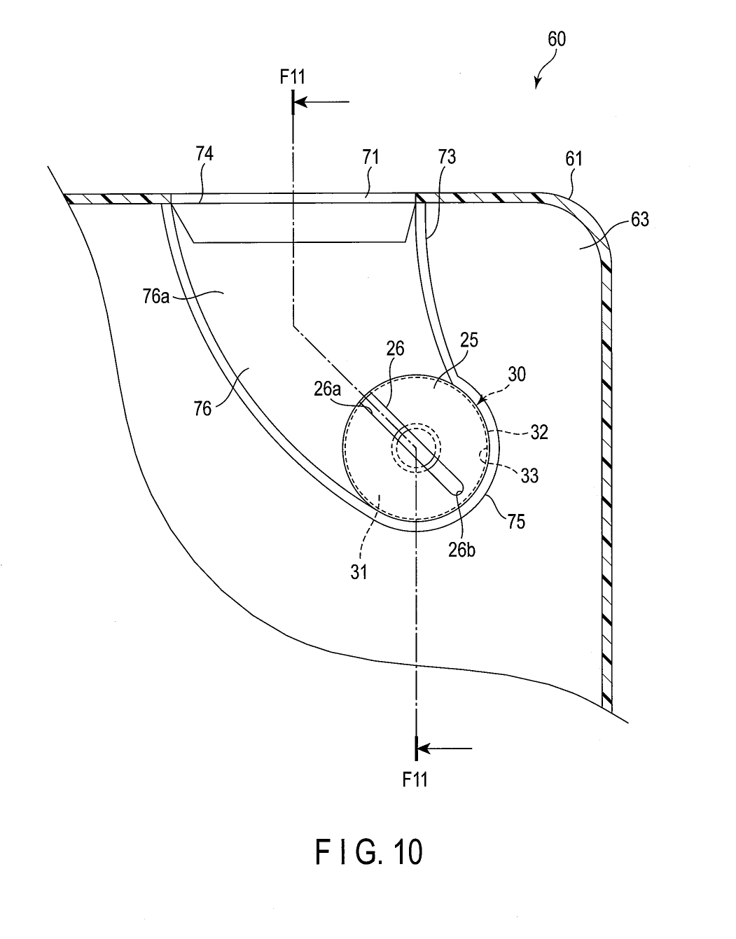

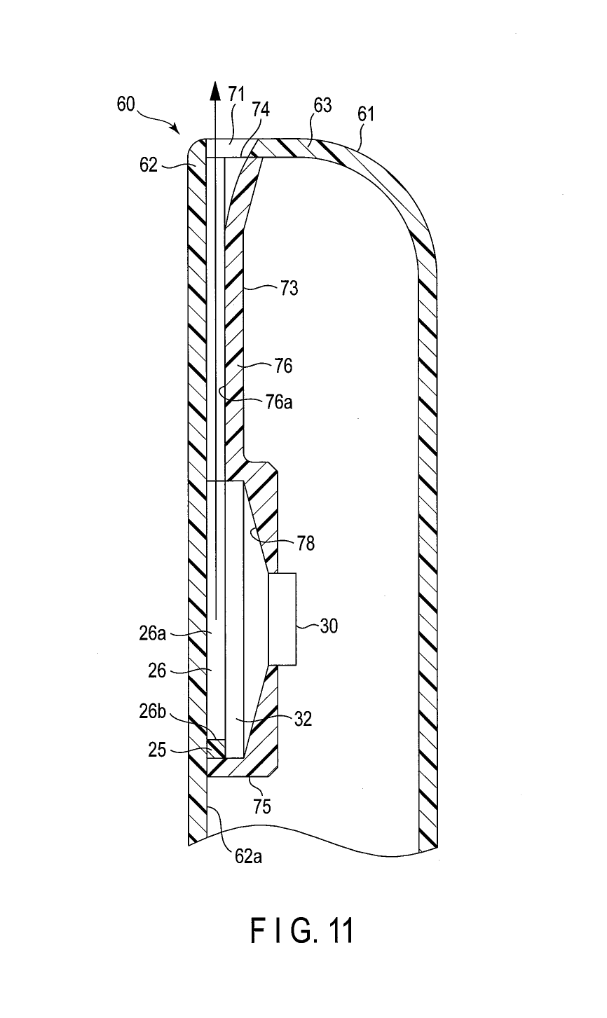

FIG. 10 is an exemplary sectional view showing a part of the tablet computer 60 around one of the output ports 71. FIG. 11 is an exemplary partial sectional view of the tablet computer 60 taken along line F11-F11 of FIG. 10. As shown in FIG. 10, the tablet housing 61 accommodates a pair of speakers 30 and a pair of sound channels 73. In other words, the speakers 30 and sound channels 73 are disposed in the tablet housing 61. The speakers 30 and sound channels 73 are located corresponding to the output ports 71.

Each sound channel 73 is a resin component secured to the front or rear cover 62 or 63. The sound channel 73 comprises first and second end portions 74 and 75 and duct portion 76. The first end portion 74 is connected to the output port 71. The second end portion 75 is in the form of a semicircular frame. The duct portion 76 is disposed between the first and second end portions 74 and 75.

As shown in FIG. 11, the upper end of the duct portion 76 is in contact with an inner surface 62a of the front cover 62. In other words, the duct portion 76 is covered by the front cover 62. Thus, the duct portion 76 forms a tubular sound path. As shown in FIG. 10, the duct portion 76 becomes wider with distance from the second end portion 75 toward the first end portion 74.

As shown in FIG. 11, the second end portion 75 comprises a recess 78. The recess 78 is recessed thicknesswise relative to the sound channel 73. Each of the speakers 30 is fitted in the recess 78.

An opening 33 of each speaker 30 is directed perpendicular to the extending direction of the duct portion 76. An end portion of a peripheral edge portion 32 of the speaker 30 in which the opening 33 opens is substantially flush with a bottom surface 76a of the duct portion 76.

A matching section 25 is fitted in the second end portion 75. In other words, the matching section 25 is located in the second end portion 75. The matching section 25 of the fifth embodiment is a component independent of the tablet housing 61.

The matching section 25 is a substantially circular plate, which covers the speaker 30. The matching section 25 is held between the speaker 30 and the inner surface 62a of the front cover 62. The matching section 25 may be secured to the speaker 30 or front cover 62 with, for example, an adhesive. Further, the matching section 25 may comprises a portion that regulates its rotation.

As shown in FIG. 10, one end portion of the slit 26 opens in the duct portion 76. In other words, the slit 26 is in the form of a notch opening in the duct portion 76. The end portion of the slit 26 opening in the duct portion 76 is directed toward the output port 71.

As shown in FIG. 11, sound output from the speaker 30 is delivered to the duct portion 76 through the opening of the slit 26. In other words, the slit 26 serves as a path of sound capable of impedance matching. The sound is output from the tablet computer 60 through the first end portion 74 and output port 71.

The first end portion 74 is formed with an expansion region 79. The expansion region 79 is a portion expanded like a horn toward the output port 71. In other words, the expansion region 79 is such a portion that the cross-sectional area of the tubular sound path defined by the duct portion 76 is extended with reduction of distance from the output port 71.

According to the fifth embodiment, the opening 33 of each speaker 30 is directed perpendicular to the extending direction of the sound channel 73, and the slit 26 opens in the sound channel 73. Since the slit 26 doubles as the path of sound, the sound is output perpendicular to the orientation of the speaker 30 with a sound pressure loss suppressed. With the slit 26 thus opening in the sound channel 73, low-frequency sound output from the speaker 30 can be satisfactorily reproduced despite the use of the sound channel 73.

The expansion region 79 at the first end portion 74 of the sound channel 73 is expanded like a horn toward the output port 71. Since the expansion region 79 is thus expanded, sound output from the speaker 30 can be amplified.

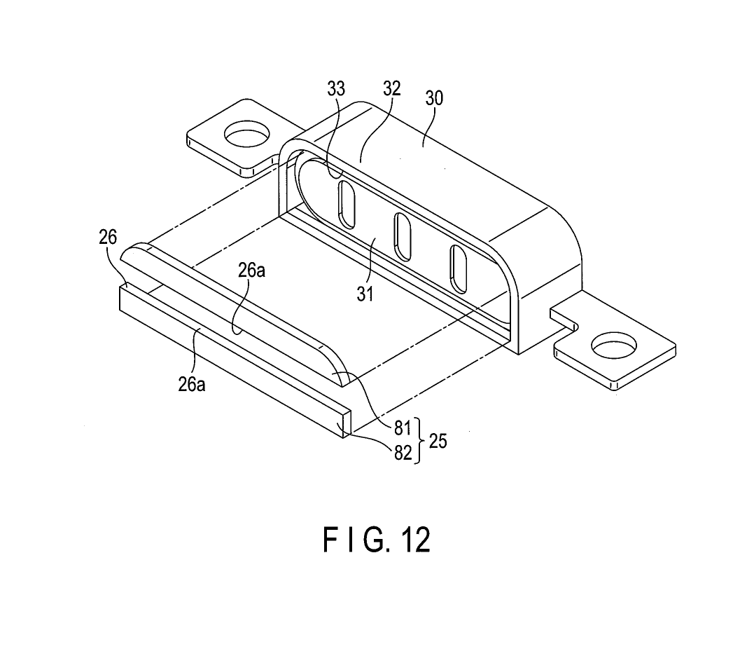

A sixth embodiment will now be described with reference to FIG. 12. FIG. 12 is an exemplary exploded perspective view showing a matching section 25 and speaker 30 according to the sixth embodiment. The speaker 30 of the sixth embodiment can be used in various electronic apparatuses, such as a notebook computer, tablet computer, smartphone, portable music player, external speaker, etc.

The speaker 30 comprises a diaphragm 31 and peripheral edge portion 32, which are rectangular. The diaphragm 31 and peripheral edge portion 32 of the speaker 30 are not limited to either the circular shape of the first embodiment or the rectangular shape of the sixth embodiment, and may alternatively be of another shape, such as elliptical.

In the sixth embodiment, the matching section 25 is an example of a sound quality improvement member. The matching section 25 comprises first and second plate-like members 81 and 82. The first and second members 81 and 82 are fitted in an opening 33 of the speaker 30. The members 81 and 82 are secured to the peripheral edge portion 32 with, for example, an adhesive.

The first and second members 81 and 82 are arranged with a gap therebetween. Thus, a slit 26 is defined between the members 81 and 82. The first and second members 81 and 82 may be formed individually with slopes such that they further define a horn-like portion.

In the sixth embodiment arranged in this manner, as in the first embodiment, impedance matching between the air and the speaker 30 can be performed by the slit 26. Thus, low-frequency sound output from the speaker 30 can be satisfactorily reproduced.

According to at least one of the electronic apparatuses described above, the matching section closes the opening of the speaker and comprises the slit through which the output section of the speaker is partially exposed. The slit serves for impedance matching between the air and the speaker, so that low-frequency sound output from the speaker can be satisfactorily reproduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the matching section 25 may be provided with a plurality of slits 26 corresponding to one speaker 30. Sound output from the speaker 30 is subjected to impedance matching by the slits 26.

What is claimed is:

1. An electronic apparatus comprising:
a speaker comprising an output section configured to output sound and an opening configured to expose the output section; and
a matching section configured to close the opening, the matching section comprising a slit configured to partially expose the output section.

2. The electronic apparatus of claim 1, wherein the slit comprises a pair of side edges extending parallel to each other.

3. The electronic apparatus of claim 1, further comprising a housing comprising the speaker and the matching section.

4. The electronic apparatus of claim 2, further comprising a housing comprising the speaker and the matching section.

5. The electronic apparatus of claim 1, wherein the matching section comprises a horn portion connected to the slit.

6. The electronic apparatus of claim 4, wherein the matching section comprises a horn portion connected to the slit.

7. The electronic apparatus of claim 1, wherein the output section is configured to be exposed through the single slit only.

8. The electronic apparatus of claim 6, wherein the output section is configured to be exposed through the single slit only.

9. The electronic apparatus of claim 1, wherein the matching section comprises a first member, a second member configured to define the slit in cooperation with the first member, and a junction configured to connect the first and second members.

10. The electronic apparatus of claim 2, wherein the matching section comprises a first member, a second member configured to define the slit in cooperation with the first member, and a junction configured to connect the first and second members.

11. The electronic apparatus of claim 1, further comprising a housing comprising the speaker and an output port opening to the outside, and a sound channel in the housing, the sound channel comprising a first end portion connected to the output port and a second end portion at which the matching section is disposed, wherein the opening is directed perpendicular to the extending direction of the sound channel and the slit opens into the sound channel.

12. The electronic apparatus of claim 2, further comprising a housing comprising the speaker and an output port opening to the outside, and a sound channel in the housing, the sound channel comprising a first end portion connected to the output port and a second end portion at which the matching section is disposed, wherein the opening is directed perpendicular to the extending direction of the sound channel and the slit opens into the sound channel.

13. The electronic apparatus of claim 11, wherein the first end portion of the sound channel is expanded like a horn toward the output port.

14. The electronic apparatus of claim 12, wherein the first end portion of the sound channel is expanded like a horn toward the output port.

15. A sound quality improvement method comprising:
mounting a speaker comprising an output section configured to output sound and an opening configured to expose the output section, with a matching section configured to close the opening and comprising a slit configured to partially expose the output section; and
causing the output section to output the sound through the slit.

16. A sound quality improvement member configured to be mounted on a speaker comprising an output section configured to output sound and an opening configured to expose the output section, the sound quality improvement member comprising:
a matching section configured to close the opening, the matching section comprising a slit configured to expose a part of the output section.

17. The electronic apparatus of claim 1, wherein the matching section comprises a baffle.

18. The sound quality improvement method of claim 15, wherein the matching section comprises a baffle.

19. The sound quality improvement member of claim 16, wherein the matching section comprises a baffle.
